(19) United States
(12) Patent Application Publication
(10) Pub. No.: US 2026/0036792 A1
(43) Pub. Date: Feb. 5, 2026

(54) OPTICAL SYSTEMS

(71) Applicant: Zhejiang Sunny Optics Co., Ltd, Yuyao City (CN)

(72) Inventors: Biran Chen, Yuyao City (CN); Xiaobin Zhang, Yuyao City (CN); Lin Huang, Yuyao City (CN)

(21) Appl. No.: 18/979,551

(22) Filed: Dec. 12, 2024

(30) Foreign Application Priority Data
Jul. 30, 2024 (CN) 202411031135.4

(51) Int. Cl. G02B 13/00; G02B 5/30

(52) U.S. Cl. CPC G02B 13/006; G02B 5/3083; G02B 13/005

(57) ABSTRACT

The present disclosure discloses an optical system, including: a first lens having a positive refractive power, a reflective polarizing element, a first quarter wave plate, a second lens having a positive refractive power, a third lens having a negative refractive power, a partially reflective element, a fourth lens having a refractive power, a second quarter wave plate and a polarizer. An effective focal length f1 of the first lens and an effective focal length f2 of the second lens satisfy: 0.15<f2/f1<1.6; and center thicknesses CT1, CTR, CTQ1 and CT2 of the first lens, the reflective polarizing element, the first quarter wave plate and the second lens respectively on the optical axis satisfy: 0.35<(CT1+CTR)/(CTQ1+CT2)<1.05.

### CROSS-REFERENCE TO RELATED APPLICATIONS

This patent application claims the priority to and benefits of Chinese Patent Application No. 202411031135.4, filed on Jul. 30, 2024 and entitled “Optical System,” the disclosure of which is incorporated herein by reference in its entirety.

### TECHNICAL FIELD

The present disclosure relates to the field of optical elements, in particular, to an optical system.

### BACKGROUND

With the continuous development of virtual reality technology, people have higher and higher requirements for imaging effects of apparatuses such as VR glasses. At the same time, the cementing technology for large-aperture optical lens assemblies is also becoming more mature. After experiencing development iterations of technical solutions such as aspheric lenses, or Fresnel lenses, currently, a refracted and reflected structure solution is highly favoured among many solutions due to its ability to significantly compress system size through optical path folding, and has gradually become the mainstream design solution for such optical systems.

### SUMMARY

The present disclosure provides an optical system, which may include, sequentially along an optical axis from a first side to a second side: a first lens having a positive refractive power; a reflective polarizing element; a first quarter wave plate; a second lens having a positive refractive power; a third lens having a negative refractive power; a partially reflective element; a fourth lens having a positive refractive power or a negative refractive power; a second quarter wave plate; and a polarizer. The reflective polarizing element is disposed on a second side surface of the first lens, a first side surface of the reflective polarizing element is at least partially adhered to the second side surface of the first lens; the first quarter wave plate is disposed on a second side surface of the reflective polarizing element, a first side surface of the first quarter wave plate is at least partially adhered to the second side surface of the reflective polarizing element, and a second side surface of the first quarter wave plate is at least partially adhered to a first side surface of the second lens; the second lens is cemented to the third lens; and the third lens is cemented to the fourth lens. The optical system satisfies: 0.15<f2/f1<1.6 and 0.35<(CT1+CTR)/(CTQ1+CT2)<1.05, where, f2 is an effective focal length of the second lens, f1 is an effective focal length of the first lens, CT1 is a center thickness of the first lens on the optical axis, CTR is a center thickness of the reflective polarizing element on the optical axis, CTQ1 is a center thickness of the first quarter wave plate on the optical axis, and CT2 is a center thickness of the second lens on the optical axis.

In an implementation, the optical system further includes a diaphragm disposed on a first side of the first lens, an effective focal length f of the optical system and a distance SR from the diaphragm to a first side surface of the first lens on the optical axis may satisfy: 1.45<f/SR<1.8.

In an implementation, an effective focal length f2 of the second lens, a refractive index N2 of the second lens, an effective focal length f3 of the third lens and a refractive index N3 of the third lens may satisfy: −0.7<(f2×N2)/(f3×N3)<−0.3.

In an implementation, the center thickness CT2 of the second lens on the optical axis, a center thickness CT3 of the third lens on the optical axis and a radius of curvature R4 of a second side surface of the second lens may satisfy: −0.4<(CT2+CT3)/R4<−0.15.

In an implementation, a center thickness CT3 of the third lens on the optical axis, an abbe number V3 of the third lens, a center thickness CT4 of the fourth lens on the optical axis and an abbe number V4 of the fourth lens may satisfy: 0.5<(CT3×V3)/(CT4×V4)<1.75.

In an implementation, a distance TD from a first side surface of the first lens to a second side surface of the fourth lens on the optical axis, the center thickness CTR of the reflective polarizing element on the optical axis, the center thickness CTQ1 of the first quarter wave plate on the optical axis and the center thickness CT2 of the second lens on the optical axis may satisfy: 2.8<TD/(CTR+CTQ1+CT2)<3.2.

In an implementation, a radius of curvature R6 of a second side surface of the third lens and a radius of curvature R5 of a first side surface of the third lens may satisfy: 1.2<R6/R5<1.6.

In an implementation, an effective focal length f of the optical system, a refractive index NR of the reflective polarizing element, a refractive index NQ1 of the first quarter wave plate, a refractive index NQ2 of the second quarter wave plate and a refractive index NL of the polarizer may satisfy: 3.7 mm<f/(NR+NQ1+NQ2+NL)<4.4 mm.

In an implementation, the center thickness CT1 of the first lens on the optical axis, an abbe number V1 of the first lens and an abbe number VR of the reflective polarizing element may satisfy: 2.5 mm<CT1/(V1/VR)<6.5 mm.

In an implementation, the effective focal length f2 of the second lens, an abbe number VQ1 of the first quarter wave plate and an abbe number V2 of the second lens may satisfy: 0.9 mm<f2/(VQ1+V2)<1.4 mm.

In an implementation, a sum of center thicknesses ΣCT of the first lens, the second lens, the third lens and the fourth lens on the optical axis and an entrance pupil diameter EPD of the optical system may satisfy: 4.4<ΣCT/EPD<5.15.

In an implementation, a radius of curvature R7 of a first side surface of the fourth lens, the abbe number V3 of the third lens and an abbe number V4 of the fourth lens may satisfy: −1.25 mm<R7/(V3+V4)<−0.5 mm.

In an implementation, an effective focal length f of the optical system and the center thickness CT2 of the second lens on the optical axis may satisfy: 3.7<f/CT2<4.2.

In an implementation, a distance TD from a first side surface of the first lens to a second side surface of the fourth lens on the optical axis, a refractive index N1 of the first lens and a refractive index N4 of the fourth lens may satisfy: 5.5 mm<TD/(N1+N4)<6.8 mm.

In an implementation, materials of the first lens, the second lens, the third lens and the fourth lens may all be plastic.

In an implementation, the first side surface and the second side surface of each of the first lens, the second lens, the third lens and the fourth lens may all be spherical surfaces.

### BRIEF DESCRIPTION OF THE DRAWINGS

Other features, objectives, and advantages of the present disclosure will become more apparent from the following detailed description of non-limiting embodiments with reference to the accompanying drawings. In the accompanying drawings:

FIG. 1 illustrates a schematic structural diagram of an optical system according to Embodiment 1 of the present disclosure;

FIG. 2 and FIG. 3 respectively illustrate a longitudinal aberration curve and a distortion curve of the optical system in Embodiment 1;

FIG. 4 illustrates a modulation transfer function (MTF) curve of the optical system in Embodiment 1;

FIG. 5 illustrates a schematic structural diagram of an optical system according to Embodiment 2 of the present disclosure;

FIG. 6 and FIG. 7 respectively illustrate a longitudinal aberration curve and a distortion curve of the optical system in Embodiment 2;

FIG. 8 illustrates a modulation transfer function (MTF) curve of the optical system in Embodiment 2;

FIG. 9 illustrates a schematic structural diagram of an optical system according to Embodiment 3 of the present disclosure;

FIG. 10 and FIG. 11 respectively illustrate a longitudinal aberration curve and a distortion curve of the optical system in Embodiment 3;

FIG. 12 illustrates a modulation transfer function (MTF) curve of the optical system in Embodiment 3;

FIG. 13 illustrates a schematic structural diagram of an optical system according to Embodiment 4 of the present disclosure;

FIG. 14 and FIG. 15 respectively illustrate a longitudinal aberration curve and a distortion curve of the optical system in Embodiment 4;

FIG. 16 illustrates a modulation transfer function (MTF) curve of the optical system in Embodiment 4;

FIG. 17 illustrates a schematic structural diagram of an optical system according to Embodiment 5 of the present disclosure;

FIG. 18 and FIG. 19 respectively illustrate a longitudinal aberration curve and a distortion curve of the optical system in Embodiment 5; and

FIG. 20 illustrates a modulation transfer function (MTF) curve of the optical system in Embodiment 5.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and the like are only used to distinguish one feature from another, rather than represent any limitations to the features. Thus, without departing from the teachings of the present disclosure, the first lens discussed below may also be referred to as the second lens, and the second lens discussed may also be referred to as the first lens.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, expressions such as “at least one of,” when preceding a list of listed features, modify the entire list of features rather than an individual element in the list. Further, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The present disclosure will be described below in detail with reference to the accompanying drawings and in combination with the embodiments.

Features, principles and other aspects of the present disclosure are described below in detail.

An optical system according to exemplary implementations of the present disclosure may include a first lens, a reflective polarizing element, a first quarter wave plate, a second lens, a third lens, a partially reflective element, a fourth lens, a second quarter wave plate, and a polarizer. In exemplary implementations, the first lens, the reflective polarizing element, the first quarter wave plate, the second lens, the third lens, the partially reflective element, the fourth lens, the second quarter wave plate, and the polarizer may be sequentially arranged along an optical axis from a first side to a second side.

In exemplary implementations, the first lens may have a positive refractive power. The second lens may have a positive refractive power. The third lens may have a negative refractive power. The fourth lens may have a positive refractive power or a negative refractive power.

In exemplary implementations, a first side surface of the first lens may be a concave surface or a convex surface, and a second side surface of the first lens may be a convex surface or a concave surface. A first side surface of the second lens may be a concave surface or a convex surface, and a second side surface of the second lens may be a convex surface. A first side surface of the third lens may be a concave surface, and a second side surface of the third lens may be a convex surface. A first side surface of the fourth lens may be a concave surface, and a second side surface of the fourth lens may be a convex surface or a concave surface.

In exemplary implementations, the reflective polarizing element may be disposed on the second side surface of the first lens, and a first side surface of the reflective polarizing element may be at least partially adhered to the second side surface of the first lens. The first quarter wave plate may be disposed on a second side surface of the reflective polarizing element, and a first side surface of the first quarter wave plate may be at least partially adhered to the second side surface of the reflective polarizing element. A second side surface of the first quarter wave plate may be at least partially adhered to the first side surface of the second lens.

In exemplary implementations, the second lens may be cemented to the third lens, for example, the second side surface of the second lens may be cemented to the first side surface of the third lens. The third lens may be cemented to the fourth lens, for example, the second side surface of the third lens may be cemented to the first side surface of the fourth lens.

In exemplary implementations, the partially reflective element may be a semi-transparent, semi-reflective film layer plated on the second side surface of the third lens. In exemplary implementations, the first side surface of the fourth lens may be cemented to the second side surface of the third lens plated with the partially reflective element.

In exemplary implementations, the partially reflective element may be a semi-transparent, semi-reflective film layer plated on the first side surface of the fourth lens. In exemplary implementations, the second side surface of the third lens may be cemented to the first side surface of the fourth lens plated with the partially reflective element.

In exemplary implementations, the optical system may further include an image surface disposed on a second side of the polarizer. The polarizer, for example, may be disposed on a first side surface of the image surface. The second quarter wave plate, for example, may be disposed on a first side surface of the polarizer, and a second side surface of the second quarter wave plate may be at least partially adhered to the first side surface of the polarizer.

In exemplary implementations, the first side, for example, may be a human eye side, and the second side, for example, may be an image surface side. The optical system, for example, may be used in VR/AR devices.

The optical system will be exemplarily described below with reference to FIG. 1. As shown in FIG. 1, the optical system according to exemplary implementations of the present disclosure may include the first lens E1, the reflective polarizing element RP, the first quarter wave plate QWP1, the second lens E2, the third lens E3, the partially reflective element BS, the fourth lens E4, the second quarter wave plate QWP2, and the polarizer LP arranged sequentially from the first side to the second side, where the reflective polarizing element RP is disposed on the second side surface of the first lens E1, the first quarter wave plate QWP1 is disposed on the second side surface of the reflective polarizing element RP, the first side surface of the second lens E2 is adhered to the second side surface of the first quarter wave plate QWP1, the third lens E3 is cemented to the second lens E2, the fourth lens E4 is cemented to the third lens E3, and the partially reflective element BS is provided between the third lens E3 and the fourth lens E4. In actual use, for example, the optical system according to the exemplary implementations of the present disclosure may be used as a VR lens assembly, where the first side corresponds to the human eye side and the second side corresponds to the image surface side. The optical system may also include, for example, an image surface IMG located on the second side of the polarizer LP. A light beam emitted from the image plane IMG may sequentially pass through the polarizer LP, the second quarter wave plate QWP2, the fourth lens E4, the partially reflective element BS, the third lens E3, the second lens E2 and the first quarter wave plate QWP1 to reach the reflective polarizing element RP, after being reflected at the reflective polarizing element RP, the light beam passes through the first quarter wave plate QWP1, the second lens E2 and the third lens E3 again to reach the partially reflective element BS, then, after being reflected again at the partially reflective element BS, the light beam sequentially passes through the third lens E3, the second lens E2, the first quarter wave plate QWP1, the reflective polarizing element RP and the first lens E1 in order to exit towards the first side (e.g., the human eye side).

In exemplary implementations, the optical system of the present disclosure may satisfy the conditional expression: 0.15<f2/f1<1.6, where, f2 is an effective focal length of the second lens, and f1 is an effective focal length of the first lens.

In exemplary implementations, the optical system of the present disclosure may satisfy the conditional expression: 0.35<(CT1+CTR)/(CTQ1+CT2)<1.05, where, CT1 is a center thickness of the first lens on the optical axis, CTR is a center thickness of the reflective polarizing element on the optical axis, CTQ1 is a center thickness of the first quarter wave plate on the optical axis, and CT2 is a center thickness of the second lens on the optical axis.

The optical system according to the exemplary implementations of the present disclosure includes, sequentially along the optical axis from the first side to the second side: the first lens having a positive refractive power, the reflective polarizing element, the first quarter wave plate, the second lens having a positive refractive power, the third lens having a negative refractive power, the partially reflective element, the fourth lens having a positive refractive power or a negative refractive power, the second quarter wave plate and the polarizer, where, the reflective polarizing element is disposed on the second side surface of the first lens and is at least partially adhered to the second side surface of the first lens, the first quarter wave plate is disposed on the second side surface of the reflective polarizing element and is at least partially adhered to the second side surface of the reflective polarizing element, and the first side surface of the second lens is at least partially adhered to the second side surface of the first quarter wave plate; the second lens is cemented to the third lens; the third lens is cemented to the fourth lens; in addition, the effective focal length f2 of the second lens and the effective focal length f1 of the first lens satisfy the conditional expression: 0.15<f2/f1<1.6, and the center thicknesses CT1, CTR, CTQ1 and CT2 of the first lens, the reflective polarizing element, the first quarter wave plate and the second lens respectively on the optical axis satisfy the conditional expression: 0.35<(CT1+CTR)/(CTQ1+CT2)<1.05. The optical system uses a polarization refracted and reflected optical path and cemented lenses, through the above settings of the optical system, by reasonably configuring the system architecture and film application method, light is first reflected and then projected to achieve the requirement of light folding, which controls a screen size of the optical system on the one hand, and a field-of-view of the optical system on the other hand. While f2 and f1 satisfying the conditional expression: 0.15<f2/f1<1.6, by controlling the system to satisfy the conditional expression: 0.35<(CT1+CTR)/(CTQ1+CT2)<1.05, it is conducive to controlling an overall thickness of the first lens and the second lens, ensuring processibility of the two lenses, while controlling the second lens to have a greater thickness, so that the optical path of the light refracted and reflected in the second lens is longer, which may improve performance of the optical system, and reduce a total length of the optical system.

In exemplary implementations, the optical system of the present disclosure may further include a diaphragm disposed on a first side of the first lens, and may satisfy the conditional expression: 1.45<f/SR<1.8, where, fis an effective focal length of the optical system, and SR is a distance from the diaphragm to the first side surface of the first lens on the optical axis. By reasonably controlling the ratio of the effective focal length of the optical system to the distance from the diaphragm to the first side surface of the first lens on the optical axis to be within this range, the total length of the optical system may be controlled to be within a small range.

In exemplary implementations, the optical system of the present disclosure may satisfy the conditional expression: −0.7<(f2×N2)/(f3×N3)<−0.3, where, f2 is the effective focal length of the second lens, N2 is a refractive index of the second lens, f3 is an effective focal length of the third lens, and N3 is a refractive index of the third lens. By controlling the optical system to satisfy the conditional expression: −0.7<(f2×N2)/(f3×N3)<−0.3, lens surface types of the second lens and the third lens may be made to meet machinability requirements, while also being able to contribute to the system performance.

In exemplary implementations, the optical system of the present disclosure may satisfy the conditional expression: −0.4<(CT2+CT3)/R4<−0.15, where, CT2 is the center thickness of the second lens on the optical axis, CT3 is a center thickness of the third lens on the optical axis, and R4 is a radius of curvature of the second side surface of the second lens. By controlling the system to satisfy the conditional expression: −0.4<(CT2+CT3)/R4<−0.15, significant surface type fluctuations in the lenses of the second lens and the third lens may be avoided, which is conducive to improving the processibility of the lenses.

In exemplary implementations, the optical system of the present disclosure may satisfy the conditional expression: 0.5<(CT3×V3)/(CT4×V4)<1.75, where, CT3 is the center thickness of the third lens on the optical axis, V3 is an abbe number of the third lens, CT4 is a center thickness of the fourth lens on the optical axis, and V4 is an abbe number of the fourth lens. By controlling the optical system to satisfy the conditional expression: 0.5<(CT3×V3)/(CT4×V4)<1.75, the third lens and the fourth lens may each undertake part of the function of reducing chromatic aberration, which is conducive to improving the performance of the optical system.

In exemplary implementations, the optical system of the present disclosure may satisfy the conditional expression: 2.8<TD/(CTR+CTQ1+CT2)<3.2, where, TD is a distance from the first side surface of the first lens to the second side surface of the fourth lens on the optical axis, CTR is the center thickness of the reflective polarizing element on the optical axis, CTQ1 is the center thickness of the first quarter wave plate on the optical axis, and CT2 is the center thickness of the second lens on the optical axis. By controlling the optical system to satisfy the conditional expression: 2.8<TD/(CTR+CTQ1+CT2)<3.2, it is conducive to reducing the total length of the optical system, as well as increasing the optical path, and improving the performance of the optical system.

In exemplary implementations, the optical system of the present disclosure may satisfy the conditional expression: 1.2<R6/R5<1.6, where, R6 is a radius of curvature of the second side surface of the third lens, and R5 is a radius of curvature of the first side surface of the third lens. By controlling the ratio of the radius of curvature of the second side surface of the third lens to the radius of curvature of the first side surface of the third lens to be within this range, it is conducive to controlling an overall lens shape of the third lens, thereby controlling the thickness ratio of the lens, and the like, which is conducive to improving the processibility of the lens.

In exemplary implementations, the optical system of the present disclosure may satisfy the conditional expression: 3.7 mm<f/(NR+NQ1+NQ2+NL)<4.4 mm, where, f is the effective focal length of the optical system, NR is a refractive index of the reflective polarizing element, NQ1 is a refractive index of the first quarter wave plate, NQ2 is a refractive index of the second quarter wave plate, and NL is a refractive index of the polarizer. By controlling the relationship between the effective focal length of the optical system and the refractive index of each film layer to satisfy the conditional expression: 3.7 mm<f/(NR+NQ1+NQ2+NL)<4.4 mm, it is conducive to reducing the chromatic aberration of the optical system, and improving the performance of the optical system.

In exemplary implementations, the optical system of the present disclosure may satisfy the conditional expression: 2.5 mm<CT1/(V1/VR)<6.5 mm, where, CT1 is the center thickness of the first lens on the optical axis, V1 is an abbe number of the first lens, and VR is an abbe number of the reflective polarizing element. By controlling the optical system to satisfy the conditional expression: 2.5 mm<CT1/(V1/VR)<6.5 mm, it is conducive to reducing the thickness of the first lens, reducing the overall total length of the optical system, thereby facilitating a thinner and lighter design.

In exemplary implementations, the optical system of the present disclosure may satisfy the conditional expression: 0.9 mm<f2/(VQ1+V2)<1.4 mm, where, f2 is the effective focal length of the second lens, VQ1 is an abbe number of the first quarter wave plate, and V2 is an abbe number of the second lens. By controlling the optical system to satisfy the conditional expression: 0.9 mm<f2/(VQ1+V2)<1.4 mm, it is conducive to improving the system's ability to converge light of different wavelengths, and improving the performance of the optical system.

In exemplary implementations, the optical system of the present disclosure may satisfy the conditional expression: 4.4<ΣCT/EPD<5.15, where, ΣCT is a sum of center thicknesses of the first lens, the second lens, the third lens and the fourth lens on the optical axis, and EPD is an entrance pupil diameter of the optical system. By controlling the optical system to satisfy the conditional expression: 4.4<ΣCT/EPD<5.15, it is conducive to reducing the total length of the optical system, while maintaining a certain entrance pupil diameter of the system.

In exemplary implementations, the optical system of the present disclosure may satisfy the conditional expression: −1.25 mm<R7/(V3+V4)<−0.5 mm, where, R7 is a radius of curvature of the first side surface of the fourth lens, V3 is the abbe number of the third lens, and V4 is the abbe number of the fourth lens. By controlling the optical system to satisfy the conditional expression: −1.25 mm<R7/(V3+V4)<−0.5 mm, it is conducive to controlling the angle of an edge field-of-view when passing through a polarizing reflector, which is conducive to reducing a polarization angle effect and the risk of ghost images.

In exemplary implementations, the optical system of the present disclosure may satisfy the conditional expression: 3.7<f/CT2<4.2, where, f is the effective focal length of the optical system, and CT2 is the center thickness of the second lens on the optical axis. By controlling the ratio of the effective focal length of the optical system to the center thickness of the second lens on the optical axis within this range, the thickness of the second lens can be better controlled, which is conducive to improving the processibility of the lens.

In exemplary implementations, the optical system of the present disclosure may satisfy the conditional expression: 5.5 mm<TD/(N1+N4)<6.8 mm, where, TD is the distance from the first side surface of the first lens to the second side surface of the fourth lens on the optical axis, N1 is a refractive index of the first lens, and N4 is a refractive index of the fourth lens. By controlling the relationship between the total length of the centers of the lenses of the system and the refractive indices of the first lens and the fourth lens to satisfy the conditional expression: 5.5 mm<TD/(N1+N4)<6.8 mm, it is conducive to reducing the total length of the optical system, and reducing an overall thickness of the apparatuses such as VR glasses.

In exemplary implementations, materials of the first lens, the second lens, the third lens and the fourth lens in the optical system of the present disclosure may all be plastic. By using the plastic materials, the lenses can be more easily molded during processing, and the weight of the lenses can also be reduced, achieving the purpose of lightweight design. In other exemplary implementations, some of the first lens, second lens, third lens, and fourth lens in the optical system of the present disclosure may also be made of plastic materials.

In exemplary implementations, in the optical system of the present disclosure, the first side surface and the second side surface of each of the first lens, the second lens, the third lens, and the fourth lens may all be spherical surfaces. Compared to the surface type of aspheric surface, spherical surfaces are easier to process, which is conducive to improving an overall tolerance and sensitivity of the system, and conducive to lowering lens cementing difficulty. In other exemplary implementations, some of the first side surface and the second side surface included in the first lens, the second lens, the third lens, and the fourth lens in the optical system of the present disclosure may also be spherical surfaces.

In exemplary implementations, the optical system of the present disclosure may include at least one diaphragm. The diaphragm may constrain the optical path and control the intensity of light. The diaphragm may be disposed at an appropriate location within the optical system, for example, the diaphragm may be located between the first side (such as the human eye side) and the first lens.

In one aspect, the optical system according to the exemplary implementations of the present disclosure includes, sequentially along an optical axis from a first side to a second side: a first lens having a positive refractive power, a reflective polarizing element, a first quarter wave plate, a second lens having a positive refractive power, a third lens having a negative refractive power, a partially reflective element, a fourth lens having a positive refractive power or a negative refractive power, a second quarter wave plate and a polarizer, where, the reflective polarizing element is disposed on a second side surface of the first lens, and a first side surface of the reflective polarizing element is at least partially adhered to the second side surface of the first lens; the first quarter wave plate is disposed on a second side surface of the reflective polarizing element, a first side surface of the first quarter wave plate is at least partially adhered to the second side surface of the reflective polarizing element, and a second side surface of the first quarter wave plate is at least partially adhered to a first side surface of the second lens; the second lens is cemented to the third lens; the third lens is cemented to the fourth lens; in addition, an effective focal length f2 of the second lens and an effective focal length f1 of the first lens satisfy the conditional expression: 0.15<f2/f1<1.6, and center thicknesses CT1, CTR, CTQ1 and CT2 of the first lens, the reflective polarizing element, the first quarter wave plate and the second lens respectively on the optical axis satisfy the conditional expression: 0.35<(CT1+CTR)/(CTQ1+CT2)<1.05. The optical system uses a polarized refraction and reflection optical path and cemented lenses, through the above settings of the optical system, by reasonably configuring the system architecture and film application method, light is first reflected and then projected to achieve the requirement of light folding, which controls a screen size of the optical system on the one hand, and a field-of-view of the optical system on the other hand. While f2 and f1 satisfying the conditional expression: 0.15<f2/f1<1.6, by controlling the system to satisfy the conditional expression: 0.35<(CT1+CTR)/(CTQ1+CT2)<1.05, it is conducive to controlling an overall thickness of the first lens and the second lens, ensuring processibility of the two lenses, while controlling the second lens to have a greater thickness, so that the optical path of the light refracted and reflected in the second lens is longer, which may improve performance of the optical system, and reduce a total length of the optical system.

In another aspect, the optical system according to exemplary implementations of the present disclosure includes, sequentially along an optical axis from a first side to a second side: a first lens having a positive refractive power, a reflective polarizing element, a first quarter wave plate, a second lens having a positive refractive power, a third lens having a negative refractive power, a partially reflective element, a fourth lens having a positive refractive power or a negative refractive power, a second quarter wave plate and a polarizer, where, the reflective polarizing element is disposed on a second side surface of the first lens, and a first side surface of the reflective polarizing element is at least partially adhered to the second side surface of the first lens; the first quarter wave plate is disposed on a second side surface of the reflective polarizing element, a first side surface of the first quarter wave plate is at least partially adhered to the second side surface of the reflective polarizing element, and a second side surface of the first quarter wave plate is at least partially adhered to a first side surface of the second lens; the second lens is cemented to the third lens; the third lens is cemented to the fourth lens; in addition, an effective focal length f2 of the second lens and an effective focal length f1 of the first lens satisfy the conditional expression: 0.15<f2/f1<1.6, an effective focal length f of the optical system, a refractive index NR of the reflective polarizing element, a refractive index NQ1 of the first quarter wave plate, a refractive index NQ2 of the second quarter wave plate and a refractive index NL of the polarizer satisfy the conditional expression: 3.7 mm<f/(NR+NQ1+NQ2+NL)<4.4 mm. The optical system uses a polarized refracted and reflected optical path and cemented lenses, through the above settings of the optical system, by reasonably configuring the system architecture and film application method, light is first reflected and then projected to achieve the requirement of light folding, which controls a screen size of the optical system on the one hand, and a field-of-view of the optical system on the other hand. While f2 and f1 satisfying the conditional expression: 0.15<f2/f1<1.6, by controlling the system to conditional satisfy the expression: 3.7 mm<f/(NR+NQ1+NQ2+NL)<4.4 mm, it is conducive to reducing the chromatic aberration of the optical system, and improving the performance of the optical system.

The optical system according to the exemplary implementations of the present disclosure uses a refracted and reflected optical system architecture with cemented spherical surfaces, by reasonably configuring the refractive powers of the lenses and the film application method and the like of the system, it may reduce the total length of the optical system, improve the performance of the optical system, and lower the difficulty in molding the lenses. The spherical surface design may also lower the lens cementing difficulty, which is conducive to improving a production yield, and reducing production costs.

In addition, the present disclosure provides a VR/AR device, the VR/AR device may include the optical system provided in any one of the above implementations, where, the first side is a human eye side and the second side is an image surface side. The VR/AR device may have characteristics such as miniaturization, light weight and high imaging quality, which enables a user to obtain a better application experience.

Specific embodiments of the optical system that may be applicable to the implementations are further described below with reference to the accompanying drawings.

### Embodiment 1

An optical system according to Embodiment 1 of the present disclosure is described below with reference to FIGS. 1-4. FIG. 1 illustrates a schematic structural diagram of the optical system according to Embodiment 1 of the present disclosure.

As shown in FIG. 1, the optical system includes, sequentially from a first side to a second side along an optical axis: a first lens E1, a reflective polarizing element RP, a first quarter wave plate QWP1, a second lens E2, a third lens E3, a partially reflective element BS, a fourth lens E4, a second quarter wave plate QWP2, a polarizer LP, and an image surface IMG. A first side surface of the reflective polarizing element RP is adhered to a second side surface of the first lens E1; a first side surface of the first quarter wave plate QWP1 is adhered to a second side surface of the reflective polarizing element RP; a first side surface of the second lens E2 is adhered to a second side surface of the first quarter wave plate QWP1; a second side surface of the second lens E2 is cemented to a first side surface of the third lens E3; the third lens E3 is cemented to the fourth lens E4, and the partially reflective element BS is between the third lens E3 and the fourth lens E4; a second side surface of the second quarter wave plate QWP2 is adhered to a first side surface of the polarizer LP; and a second side surface of the polarizer LP is provided on a first side of the image surface IMG.

In this embodiment, the first lens E1 has a positive refractive power, a first side surface of the first lens E1 is a concave surface, and the second side surface of the first lens E1 is a convex surface. The second lens E2 has a positive refractive power, the first side surface of the second lens E2 is a concave surface, and the second side surface of the second lens E2 is a convex surface. The third lens E3 has a negative refractive power, the first side surface of the third lens E3 is a concave surface, and a second side surface of the third lens E3 is a convex surface. The fourth lens E4 has a positive refractive power, a first side surface of the fourth lens E4 is a concave surface, and a second side surface of the fourth lens E4 is a convex surface.

In this embodiment, a light beam emitted from the image plane IMG on the second side of the system may sequentially pass through the polarizer LP, the second quarter wave plate QWP2, the fourth lens E4, the partially reflective element BS, the third lens E3, the second lens E2 and the first quarter wave plate QWP 1 to reach the reflective polarizing element RP, after being reflected at the reflective polarizing element RP, the light beam passes through the first quarter wave plate QWP1, the second lens E2 and the third lens E3 again to reach the partially reflective element BS, then, after being reflected again at the partially reflective element BS, the light beam sequentially passes through the third lens E3, the second lens E2, the first quarter wave plate QWP1, the reflective polarizing element RP and the first lens E1, and exits towards, for example, a diaphragm STO on the first side.

Table 1 shows basic parameters of the optical system in Embodiment 1. Here, the units of a radius of curvature and a thickness are millimeters (mm).

TABLE 1

| | | surface | radius of | | refractive | abbe | refraction/ |
|---|---|---|---|---|---|---|---|
| surface | element | type | curvature | thickness | index | number | reflection |
| S0 | | spherical | infinite | −1300.0000 | | | refraction |
| S1 | diaphragm | spherical | infinite | 15.0000 | | | refraction |
| | (STO) | | | | | | |
| S2 | first lens | spherical | −125.7479 | 4.9948 | 1.538 | 55.71 | refraction |
| | (E1) | | | | | | |
| S3 | reflective | spherical | −46.4515 | 0.1100 | 1.503 | 57.00 | refraction |
| | polarizing | | | | | | |
| | element (RP) | | | | | | |
| S4 | first quarter | spherical | −46.4515 | 0.1100 | 1.503 | 57.00 | refraction |
| | wave plate | | | | | | |
| | (QWP1) | | | | | | |
| S5 | second | spherical | −46.4515 | 6.0643 | 1.538 | 55.71 | refraction |
| | lens (E2) | | | | | | |
| S6 | third lens | spherical | −30.1679 | 5.6809 | 1.644 | 23.98 | refraction |
| | (E3) | | | | | | |
| S7 | partially | spherical | −42.1428 | −5.6809 | 1.644 | 23.98 | reflection |
| | reflective | | | | | | |
| | elements (BS) | | | | | | |
| S8 | | spherical | −30.1679 | −6.0643 | 1.538 | 55.71 | refraction |
| S9 | | spherical | −46.4515 | −0.1100 | 1.503 | 57.00 | refraction |
| S10 | reflective | spherical | −46.4515 | 0.1100 | 1.503 | 57.00 | reflection |
| | polarizing | | | | | | |
| | element (RP)) | | | | | | |
| S11 | second | spherical | −46.4515 | 6.0643 | 1.538 | 55.71 | refraction |
| | lens (E2) | | | | | | |
| S12 | third lens | spherical | −30.1679 | 5.6809 | 1.644 | 23.98 | refraction |
| | (E3) | | | | | | |
| S13 | fourth | spherical | −42.1428 | 2.8158 | 1.538 | 55.71 | refraction |
| | lens (E4) | | | | | | |
| S14 | | spherical | −38.9267 | 3.4893 | | | refraction |
| S15 | second | spherical | infinite | 0.1100 | 1.503 | 57.00 | refraction |
| | quarter wave | | | | | | |
| | plate (QWP2)) | | | | | | |
| S16 | polarizer (LP) | spherical | infinite | 0.1500 | 1.503 | 57.00 | refraction |
| S17 | | spherical | infinite | 0.0000 | | | refraction |
| S18 | image | spherical | infinite | 0.0000 | | | refraction |
| | Surface (IMG) | | | | | | |

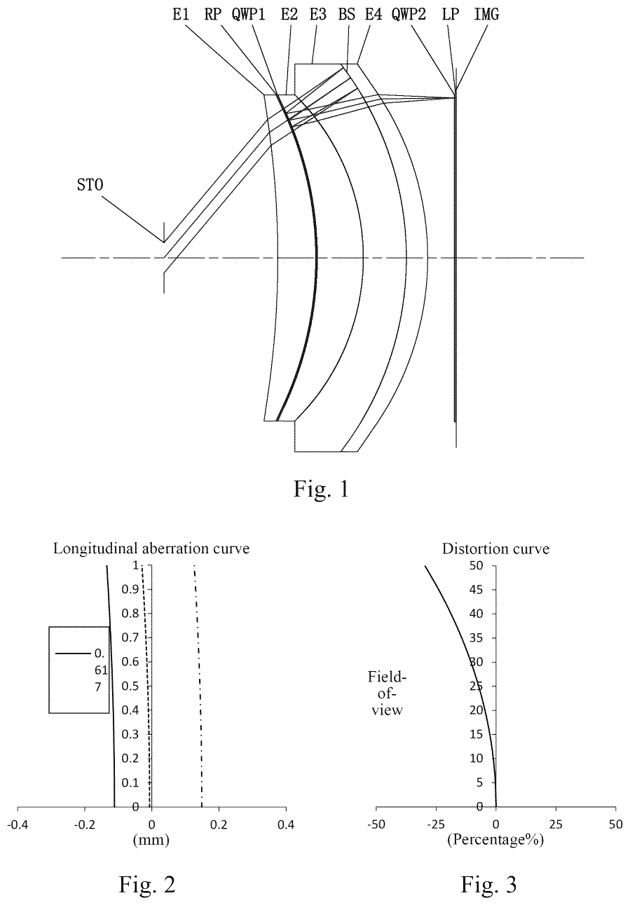

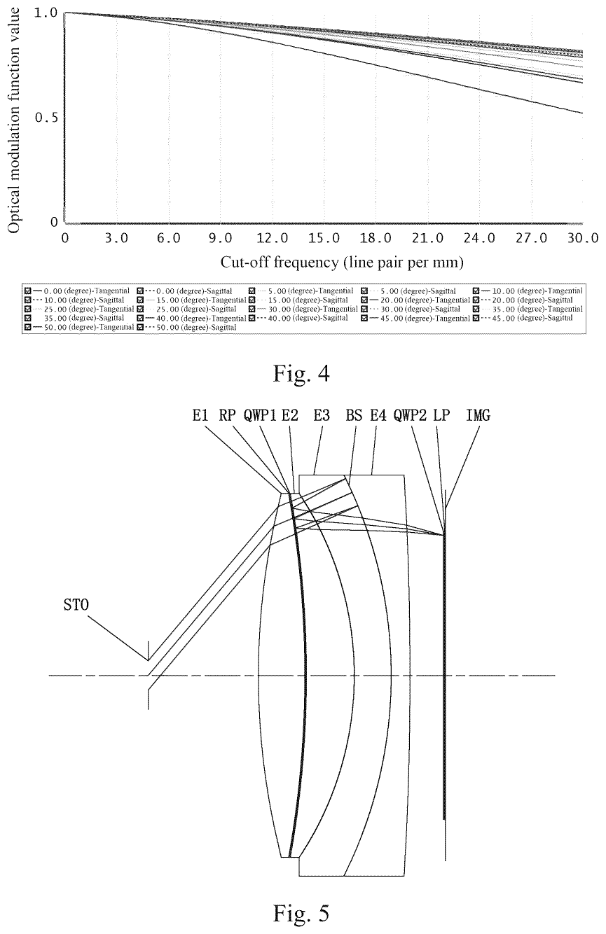

FIG. 2 illustrates a longitudinal aberration curve of the optical system in Embodiment 1, representing deviations of focal points at which lights of different wavelengths passing through the lens assembly converge. FIG. 3 illustrates a distortion curve of the optical system in Embodiment 1, representing amounts of distortion corresponding to different fields-of-view. FIG. 4 illustrates a modulation transfer function (MTF) curve of the optical system in Embodiment 1, representing values of the optical modulation function corresponding to different cut-off frequencies. It can be seen from FIGS. 2-4 that the optical system given in Embodiment 1 can achieve a good imaging quality.

### Embodiment 2

An optical system according to Embodiment 2 of the present disclosure is described below with reference to FIGS. 5-8. FIG. 5 illustrates a schematic structural diagram of the optical system according to Embodiment 2 of the present disclosure.

As shown in FIG. 5, the optical system includes, sequentially from a first side to a second side along an optical axis: a first lens E1, a reflective polarizing element RP, a first quarter wave plate QWP1, a second lens E2, a third lens E3, a partially reflective element BS, a fourth lens E4, a second quarter wave plate QWP2, a polarizer LP, and an image surface IMG. A first side surface of the reflective polarizing element RP is adhered to a second side surface of the first lens E1; a first side surface of the first quarter wave plate QWP1 is adhered to a second side surface of the reflective polarizing element RP; a first side surface of the second lens E2 is adhered to a second side surface of the first quarter wave plate QWP1; a second side surface of the second lens E2 is cemented to a first side surface of the third lens E3; the third lens E3 is cemented to the fourth lens E4, and the partially reflective element BS is between the third lens E3 and the fourth lens E4; a second side surface of the second quarter wave plate QWP2 is adhered to a first side surface of the polarizer LP; and a second side surface of the polarizer LP is provided on a first side of the image surface IMG.

In this embodiment, the first lens E1 has a positive refractive power, a first side surface of the first lens E1 is a convex surface, and the second side surface of the first lens E1 is a convex surface. The second lens E2 has a positive refractive power, the first side surface of the second lens E2 is a concave surface, and the second side surface of the second lens E2 is a convex surface. The third lens E3 has a negative refractive power, the first side surface of the third lens E3 is a concave surface, and a second side surface of the third lens E3 is a convex surface. The fourth lens E4 has a positive refractive power, a first side surface of the fourth lens E4 is a concave surface, and a second side surface of the fourth lens E4 is a convex surface.

In this embodiment, a light beam emitted from the image plane IMG on the second side of the system may sequentially pass through the polarizer LP, the second quarter wave plate QWP2, the fourth lens E4, the partially reflective element BS, the third lens E3, the second lens E2 and the first quarter wave plate QWP1 to reach the reflective polarizing element RP, after being reflected at the reflective polarizing element RP, the light beam passes through the first quarter wave plate QWP1, the second lens E2 and the third lens E3 again to reach the partially reflective element BS, then, after being reflected again at the partially reflective element BS, the light beam sequentially passes through the third lens E3, the second lens E2, the first quarter wave plate QWP1, the reflective polarizing element RP and the first lens E1, and exits towards, for example, a diaphragm STO on the first side.

Table 2 shows basic parameters of the optical system in this embodiment. Here, the units of a radius of curvature and a thickness are millimeters (mm).

TABLE 2

| | | surface | radius of | | refractive | abbe | refraction/ |
|---|---|---|---|---|---|---|---|
| surface | element | type | curvature | thickness | index | number | reflection |
| S0 | | spherical | infinite | −1300.0000 | | | refraction |
| S1 | diaphragm | spherical | infinite | 15.0000 | | | refraction |
| | (STO) | | | | | | |
| S2 | first lens | spherical | 100.0000 | 6.3192 | 1.538 | 55.71 | refraction |
| | (E1) | | | | | | |
| S3 | reflective | spherical | −141.3367 | 0.1100 | 1.503 | 57.00 | refraction |
| | polarizing | | | | | | |
| | element (RP) | | | | | | |
| S4 | first quarter | spherical | −141.3367 | 0.1100 | 1.503 | 57.00 | refraction |
| | wave plate | | | | | | |
| | (QWP1) | | | | | | |
| S5 | second | spherical | −141.3367 | 6.5172 | 1.538 | 55.71 | refraction |
| | lens (E2) | | | | | | |
| S6 | third lens | spherical | −44.9642 | 5.0260 | 1.644 | 23.98 | refraction |
| | (E3) | | | | | | |
| S7 | partially | spherical | −61.5267 | −5.0260 | 1.644 | 23.98 | reflection |
| | reflective | | | | | | |
| | elements (BS) | | | | | | |
| S8 | | spherical | −44.9642 | −6.5172 | 1.538 | 55.71 | refraction |
| S9 | | spherical | −141.3367 | −0.1100 | 1.503 | 57.00 | refraction |
| S10 | reflective | spherical | −141.3367 | 0.1100 | 1.503 | 57.00 | reflection |
| | polarizing | | | | | | |
| | element (RP)) | | | | | | |
| S11 | second | spherical | −141.3367 | 6.5172 | 1.538 | 55.71 | refraction |
| | lens (E2) | | | | | | |
| S12 | third lens | spherical | −44.9642 | 5.0260 | 1.644 | 23.98 | refraction |
| | (E3) | | | | | | |
| S13 | fourth | spherical | −61.5267 | 2.5569 | 1.538 | 55.71 | refraction |
| | lens (E4) | | | | | | |
| S14 | | spherical | −483.8579 | 4.5557 | | | refraction |
| S15 | second | spherical | infinite | 0.1100 | 1.503 | 57.00 | refraction |
| | quarter wave | | | | | | |
| | plate (QWP2)) | | | | | | |
| S16 | polarizer (LP) | spherical | infinite | 0.1500 | 1.503 | 57.00 | refraction |
| S17 | | spherical | infinite | 0.0000 | | | refraction |
| S18 | image | spherical | infinite | 0.0000 | | | refraction |
| | Surface (IMG) | | | | | | |

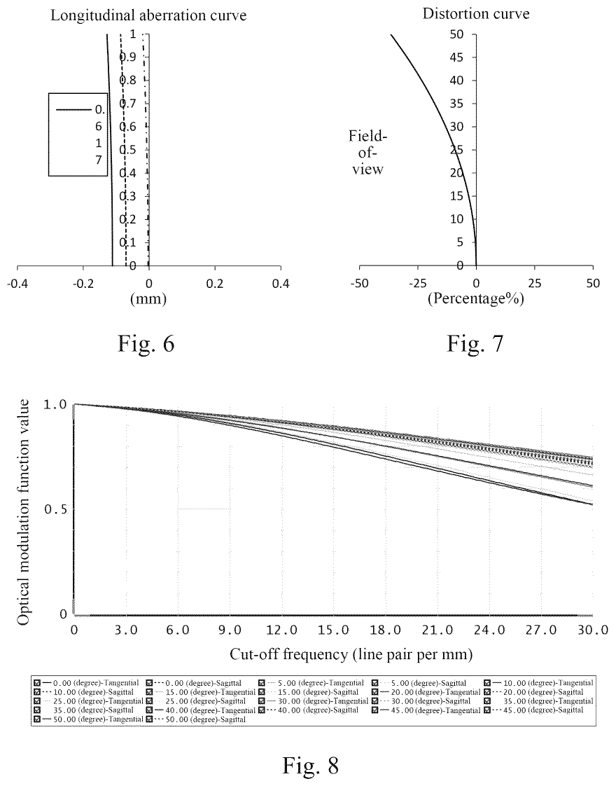

FIG. 6 illustrates a longitudinal aberration curve of the optical system in Embodiment 2, representing deviations of focal points at which lights of different wavelengths passing through the lens assembly converge. FIG. 7 illustrates a distortion curve of the optical system in Embodiment 2, representing amounts of distortion corresponding to different fields-of-view. FIG. 8 illustrates a modulation transfer function (MTF) curve of the optical system in Embodiment 2, representing values of the optical modulation function corresponding to different cut-off frequencies. It can be seen from FIGS. 6-8 that the optical system given in Embodiment 2 can achieve a good imaging quality.

### Embodiment 3

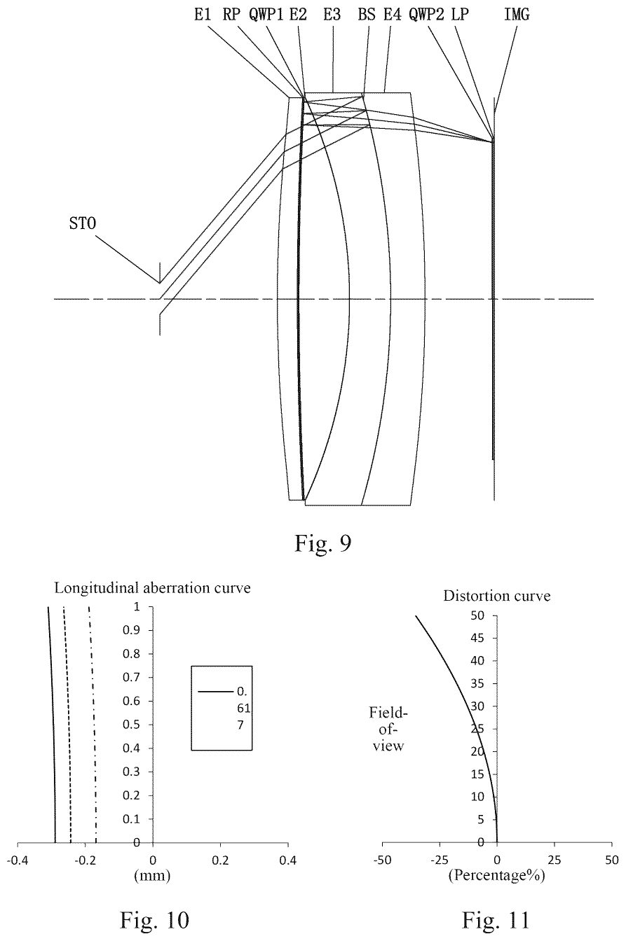

An optical system according to Embodiment 3 of the present disclosure is described below with reference to FIGS. 9-12. FIG. 9 illustrates a schematic structural diagram of the optical system according to Embodiment 3 of the present disclosure.

As shown in FIG. 9, the optical system includes, sequentially from a first side to a second side along an optical axis: a first lens E1, a reflective polarizing element RP, a first quarter wave plate QWP1, a second lens E2, a third lens E3, a partially reflective element BS, a fourth lens E4, a second quarter wave plate QWP2, a polarizer LP, and an image surface IMG. A first side surface of the reflective polarizing element RP is adhered to a second side surface of the first lens E1; a first side surface of the first quarter wave plate QWP1 is adhered to a second side surface of the reflective polarizing element RP; a first side surface of the second lens E2 is adhered to a second side surface of the first quarter wave plate QWP1; a second side surface of the second lens E2 is cemented to a first side surface of the third lens E3; the third lens E3 is cemented to the fourth lens E4, and the partially reflective element BS is between the third lens E3 and the fourth lens E4; a second side surface of the second quarter wave plate QWP2 is adhered to a first side surface of the polarizer LP; and a second side surface of the polarizer LP is provided on a first side of the image surface IMG.

In this embodiment, the first lens E1 has a positive refractive power, a first side surface of the first lens E1 is a convex surface, and the second side surface of the first lens E1 is a concave surface. The second lens E2 has a positive refractive power, the first side surface of the second lens E2 is a convex surface, and the second side surface of the second lens E2 is a convex surface. The third lens E3 has a negative refractive power, the first side surface of the third lens E3 is a concave surface, and a second side surface of the third lens E3 is a convex surface. The fourth lens E4 has a negative refractive power, a first side surface of the fourth lens E4 is a concave surface, and a second side surface of the fourth lens E4 is a convex surface.

In this embodiment, a light beam emitted from the image plane IMG on the second side of the system may sequentially pass through the polarizer LP, the second quarter wave plate QWP2, the fourth lens E4, the partially reflective element BS, the third lens E3, the second lens E2 and the first quarter wave plate QWP1 to reach the reflective polarizing element RP, after being reflected at the reflective polarizing element RP, the light beam passes through the first quarter wave plate QWP1, the second lens E2 and the third lens E3 again to reach the partially reflective element BS, then, after being reflected again at the partially reflective element BS, the light beam sequentially passes through the third lens E3, the second lens E2, the first quarter wave plate QWP1, the reflective polarizing element RP and the first lens E1, and exits towards, for example, a diaphragm STO on the first side.

Table 3 shows basic parameters of the optical system in this embodiment. Here, the units of a radius of curvature and a thickness are millimeters (mm).

TABLE 3

| | | surface | radius of | | refractive | abbe | refraction/ |
|---|---|---|---|---|---|---|---|
| surface | element | type | curvature | thickness | index | number | reflection |
| S0 | | spherical | infinite | −1300.0000 | | | refraction |
| S1 | diaphragm | spherical | infinite | 15.0000 | | | refraction |
| | (STO) | | | | | | |
| S2 | first lens | spherical | 205.3471 | 2.5374 | 1.538 | 55.71 | refraction |
| | (E1) | | | | | | |
| S3 | reflective | spherical | 500.0000 | 0.1100 | 1.503 | 57.00 | refraction |
| | polarizing | | | | | | |
| | element (RP) | | | | | | |
| S4 | first quarter | spherical | 500.0000 | 0.1100 | 1.503 | 57.00 | refraction |
| | wave plate | | | | | | |
| | (QWP1) | | | | | | |
| S5 | second | spherical | 500.0000 | 6.4562 | 1.538 | 55.71 | refraction |
| | lens (E2) | | | | | | |
| S6 | third lens | spherical | −62.0402 | 5.2513 | 1.644 | 23.98 | refraction |
| | (E3) | | | | | | |
| S7 | partially | spherical | −95.6871 | −5.2513 | 1.644 | 23.98 | reflection |
| | reflective | | | | | | |
| | elements (BS) | | | | | | |
| S8 | | spherical | −62.0402 | −6.4562 | 1.538 | 55.71 | refraction |
| S9 | | spherical | 500.0000 | −0.1100 | 1.503 | 57.00 | refraction |
| S10 | reflective | spherical | 500.0000 | 0.1100 | 1.503 | 57.00 | reflection |
| | polarizing | | | | | | |
| | element (RP)) | | | | | | |
| S11 | second | spherical | 500.0000 | 6.4562 | 1.538 | 55.71 | refraction |
| | lens (E2) | | | | | | |
| S12 | third lens | spherical | −62.0402 | 5.2513 | 1.644 | 23.98 | refraction |
| | (E3) | | | | | | |
| S13 | fourth | spherical | −95.6871 | 4.3812 | 1.538 | 55.71 | refraction |
| | lens (E4) | | | | | | |
| S14 | | spherical | −185.4626 | 8.5752 | | | refraction |
| S15 | second quarter | spherical | infinite | 0.1100 | 1.503 | 57.00 | refraction |
| | wave plate | | | | | | |
| | (QWP2)) | | | | | | |
| S16 | polarizer (LP) | spherical | infinite | 0.1500 | 1.503 | 57.00 | refraction |
| S17 | | spherical | infinite | 0.0000 | | | refraction |
| S18 | image | spherical | infinite | 0.0000 | | | refraction |
| | Surface (IMG) | | | | | | |

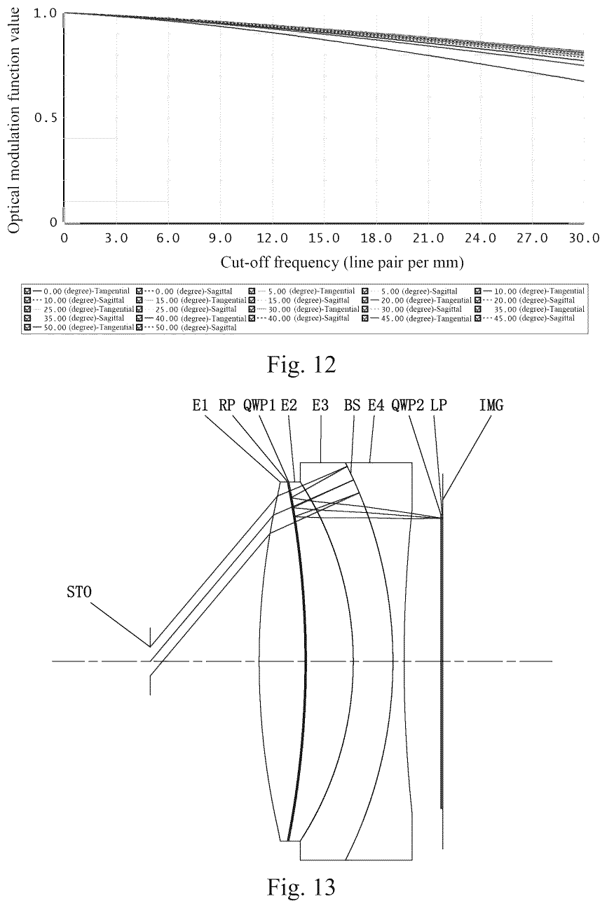

FIG. 10 illustrates a longitudinal aberration curve of the optical system in Embodiment 3, representing deviations of focal points at which lights of different wavelengths passing through the lens assembly converge. FIG. 11 illustrates a distortion curve of the optical system in Embodiment 3, representing amounts of distortion corresponding to different fields-of-view. FIG. 12 illustrates a modulation transfer function (MTF) curve of the optical system in Embodiment 3, representing values of the optical modulation function corresponding to different cut-off frequencies. It can be seen from FIGS. 10-12 that the optical system given in Embodiment 3 can achieve a good imaging quality.

### Embodiment 4

An optical system according to Embodiment 4 of the present disclosure is described below with reference to FIGS. 13-16. FIG. 13 illustrates a schematic structural diagram of the optical system according to Embodiment 4 of the present disclosure.

As shown in FIG. 13, the optical system includes, sequentially from a first side to a second side along an optical axis: a first lens E1, a reflective polarizing element RP, a first quarter wave plate QWP1, a second lens E2, a third lens E3, a partially reflective element BS, a fourth lens E4, a second quarter wave plate QWP2, a polarizer LP, and an image surface IMG. A first side surface of the reflective polarizing element RP is adhered to a second side surface of the first lens E1; a first side surface of the first quarter wave plate QWP1 is adhered to a second side surface of the reflective polarizing element RP; a first side surface of the second lens E2 is adhered to a second side surface of the first quarter wave plate QWP1; a second side surface of the second lens E2 is cemented to a first side surface of the third lens E3; the third lens E3 is cemented to the fourth lens E4, and the partially reflective element BS is between the third lens E3 and the fourth lens E4; a second side surface of the second quarter wave plate QWP2 is adhered to a first side surface of the polarizer LP; and a second side surface of the polarizer LP is provided on a first side of the image surface IMG.

In this embodiment, the first lens E1 has a positive refractive power, a first side surface of the first lens E1 is a convex surface, and the second side surface of the first lens E1 is a convex surface. The second lens E2 has a positive refractive power, the first side surface of the second lens E2 is a concave surface, and the second side surface of the second lens E2 is a convex surface. The third lens E3 has a negative refractive power, the first side surface of the third lens E3 is a concave surface, and a second side surface of the third lens E3 is a convex surface. The fourth lens E4 has a negative refractive power, a first side surface of the fourth lens E4 is a concave surface, and a second side surface of the fourth lens E4 is a concave surface.

In this embodiment, a light beam emitted from the image plane IMG on the second side of the system may sequentially pass through the polarizer LP, the second quarter wave plate QWP2, the fourth lens E4, the partially reflective element BS, the third lens E3, the second lens E2 and the first quarter wave plate QWP1 to reach the reflective polarizing element RP, after being reflected at the reflective polarizing element RP, the light beam passes through the first quarter wave plate QWP1, the second lens E2 and the third lens E3 again to reach the partially reflective element BS, then, after being reflected again at the partially reflective element BS, the light beam sequentially passes through the third lens E3, the second lens E2, the first quarter wave plate QWP1, the reflective polarizing element RP and the first lens E1, and exits towards, for example, a diaphragm STO on the first side.

Table 4 shows basic parameters of the optical system in this embodiment. Here, the units of a radius of curvature and a thickness are millimeters (mm).

TABLE 4

| | | surface | radius of | | refractive | abbe | refraction/ |
|---|---|---|---|---|---|---|---|
| surface | element | type | curvature | thickness | index | number | reflection |
| S0 | | spherical | infinite | −1300.0000 | | | refraction |
| S1 | diaphragm | spherical | infinite | 15.0000 | | | refraction |
| | (STO) | | | | | | |
| S2 | first lens | spherical | 104.8000 | 6.2945 | 1.538 | 55.71 | refraction |
| | (E1) | | | | | | |
| S3 | reflective | spherical | −128.6177 | 0.1100 | 1.503 | 57.00 | refraction |
| | polarizing | | | | | | |
| | element (RP) | | | | | | |
| S4 | first quarter | spherical | −128.6177 | 0.1100 | 1.503 | 57.00 | refraction |
| | wave plate | | | | | | |
| | (QWP1) | | | | | | |
| S5 | second | spherical | −128.6177 | 6.4535 | 1.538 | 55.71 | refraction |
| | lens (E2) | | | | | | |
| S6 | third lens | spherical | −45.8194 | 5.4640 | 1.644 | 23.98 | refraction |
| | (E3) | | | | | | |
| S7 | partially | spherical | −60.9221 | −5.4640 | 1.644 | 23.98 | reflection |
| | reflective | | | | | | |
| | elements (BS) | | | | | | |
| S8 | | spherical | −45.8194 | −6.4535 | 1.538 | 55.71 | refraction |
| S9 | | spherical | −128.6177 | −0.1100 | 1.503 | 57.00 | refraction |
| S10 | reflective | spherical | −128.6177 | 0.1100 | 1.503 | 57.00 | reflection |
| | polarizing | | | | | | |
| | element (RP)) | | | | | | |
| S11 | second | spherical | −128.6177 | 6.4535 | 1.538 | 55.71 | refraction |
| | lens (E2) | | | | | | |
| S12 | third lens | spherical | −45.8194 | 5.4640 | 1.644 | 23.98 | refraction |
| | (E3) | | | | | | |
| S13 | fourth | spherical | −60.9221 | 1.5360 | 1.538 | 55.71 | refraction |
| | lens (E4) | | | | | | |
| S14 | | spherical | 200.0000 | 5.0622 | | | refraction |
| S15 | second quarter | spherical | infinite | 0.1100 | 1.503 | 57.00 | refraction |
| | wave plate | | | | | | |
| | (QWP2)) | | | | | | |
| S16 | polarizer (LP) | spherical | infinite | 0.1500 | 1.503 | 57.00 | refraction |
| S17 | | spherical | infinite | 0.0000 | | | refraction |
| S18 | image | spherical | infinite | 0.0000 | | | refraction |
| | Surface (IMG) | | | | | | |

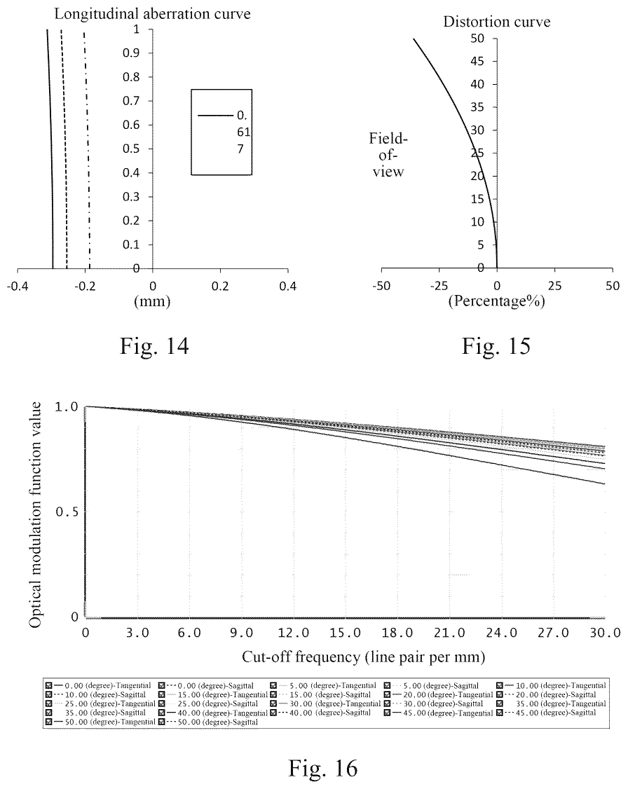

FIG. 14 illustrates a longitudinal aberration curve of the optical system in Embodiment 4, representing deviations of focal points at which lights of different wavelengths passing through the lens assembly converge. FIG. 15 illustrates a distortion curve of the optical system in Embodiment 4, representing amounts of distortion corresponding to different fields-of-view. FIG. 16 illustrates a modulation transfer function (MTF) curve of the optical system in Embodiment 4, representing values of the optical modulation function corresponding to different cut-off frequencies. It can be seen from FIGS. 14-16 that the optical system given in Embodiment 4 can achieve a good imaging quality.

### Embodiment 5

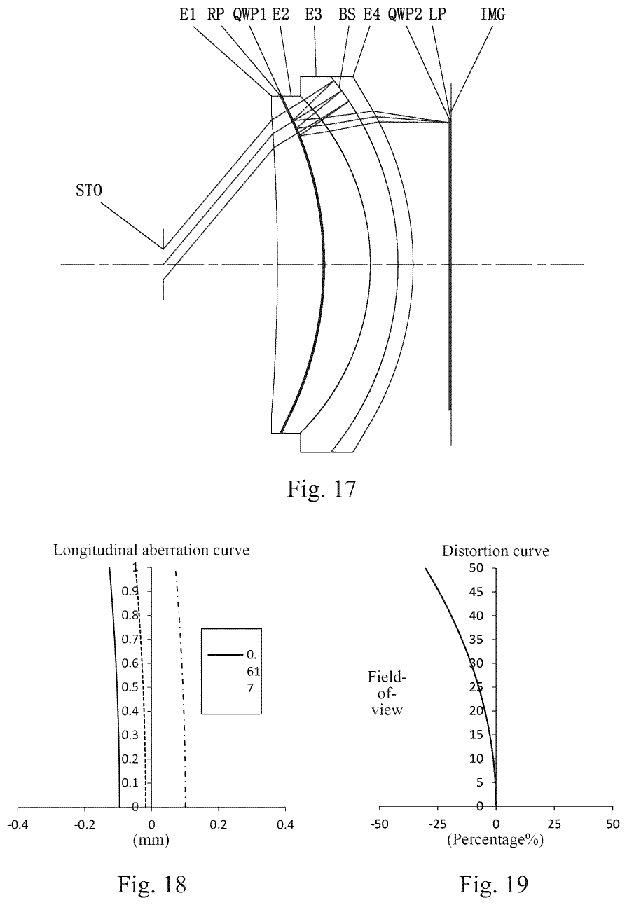

An optical system according to Embodiment 5 of the present disclosure is described below with reference to FIGS. 17-20. FIG. 17 illustrates a schematic structural diagram of the optical system according to Embodiment 5 of the present disclosure.

As shown in FIG. 17, the optical system includes, sequentially from a first side to a second side along an optical axis: a first lens E1, a reflective polarizing element RP, a first quarter wave plate QWP1, a second lens E2, a third lens E3, a partially reflective element BS, a fourth lens E4, a second quarter wave plate QWP2, a polarizer LP, and an image surface IMG. A first side surface of the reflective polarizing element RP is adhered to a second side surface of the first lens E1; a first side surface of the first quarter wave plate QWP1 is adhered to a second side surface of the reflective polarizing element RP; a first side surface of the second lens E2 is adhered to a second side surface of the first quarter wave plate QWP1; a second side surface of the second lens E2 is cemented to a first side surface of the third lens E3; the third lens E3 is cemented to the fourth lens E4, and the partially reflective element BS is between the third lens E3 and the fourth lens E4; a second side surface of the second quarter wave plate QWP2 is adhered to a first side surface of the polarizer LP; and a second side surface of the polarizer LP is provided on a first side of the image surface IMG.

In this embodiment, the first lens E1 has a positive refractive power, a first side surface of the first lens E1 is a concave surface, and the second side surface of the first lens E1 is a convex surface. The second lens E2 has a positive refractive power, the first side surface of the second lens E2 is a concave surface, and the second side surface of the second lens E2 is a convex surface. The third lens E3 has a negative refractive power, the first side surface of the third lens E3 is a concave surface, and a second side surface of the third lens E3 is a convex surface. The fourth lens E4 has a negative refractive power, a first side surface of the fourth lens E4 is a concave surface, and a second side surface of the fourth lens E4 is a convex surface.

In this embodiment, a light beam emitted from the image plane IMG on the second side of the system may sequentially pass through the polarizer LP, the second quarter wave plate QWP2, the fourth lens E4, the partially reflective element BS, the third lens E3, the second lens E2 and the first quarter wave plate QWP1 to reach the reflective polarizing element RP, after being reflected at the reflective polarizing element RP, the light beam passes through the first quarter wave plate QWP1, the second lens E2 and the third lens E3 again to reach the partially reflective element BS, then, after being reflected again at the partially reflective element BS, the light beam sequentially passes through the third lens E3, the second lens E2, the first quarter wave plate QWP1, the reflective polarizing element RP and the first lens E1, and exits towards, for example, a diaphragm STO on the first side.

Table 5 shows basic parameters of the optical system in this embodiment. Here, the units of a radius of curvature and a thickness are millimeters (mm).

TABLE 5

| | | surface | radius of | | refractive | abbe | refraction/ |
|---|---|---|---|---|---|---|---|
| surface | element | type | curvature | thickness | index | number | reflection |
| S0 | | spherical | infinite | −1300.0000 | | | refraction |
| S1 | diaphragm | spherical | infinite | 15.0000 | | | refraction |
| | (STO) | | | | | | |
| S2 | first lens | spherical | −250.5385 | 6.0098 | 1.547 | 56.14 | refraction |
| | (E1) | | | | | | |
| S3 | reflective | spherical | −45.4795 | 0.1100 | 1.503 | 57.00 | refraction |
| | polarizing | | | | | | |
| | element (RP) | | | | | | |
| S4 | first quarter | spherical | −45.4795 | 0.1100 | 1.503 | 57.00 | refraction |
| | wave plate | | | | | | |
| | (QWP1) | | | | | | |
| S5 | second | spherical | −45.4795 | 6.0109 | 1.547 | 56.14 | refraction |
| | lens (E2) | | | | | | |
| S6 | third lens | spherical | −31.1752 | 3.6196 | 1.672 | 20.37 | refraction |
| | (E3) | | | | | | |
| S7 | partially | spherical | −38.8975 | −3.6196 | 1.672 | 20.37 | reflection |
| | reflective | | | | | | |
| | elements (BS) | | | | | | |
| S8 | | spherical | −31.1752 | −6.0109 | 1.547 | 56.14 | refraction |
| S9 | | spherical | −45.4795 | −0.1100 | 1.503 | 57.00 | refraction |
| S10 | reflective | spherical | −45.4795 | 0.1100 | 1.503 | 57.00 | reflection |
| | polarizing | | | | | | |
| | element (RP)) | | | | | | |
| S11 | second | spherical | −45.4795 | 6.0109 | 1.547 | 56.14 | refraction |
| | lens (E2) | | | | | | |
| S12 | third lens | spherical | −31.1752 | 3.6196 | 1.672 | 20.37 | refraction |
| | (E3) | | | | | | |
| S13 | fourth | spherical | −38.8975 | 1.9958 | 1.661 | 21.52 | refraction |
| | lens (E4) | | | | | | |
| S14 | | spherical | −41.2873 | 4.7464 | | | refraction |
| S15 | second quarter | spherical | infinite | 0.1100 | 1.503 | 57.00 | refraction |
| | wave plate | | | | | | |
| | (QWP2)) | | | | | | |
| S16 | polarizer (LP) | spherical | infinite | 0.1500 | 1.503 | 57.00 | refraction |
| S17 | | spherical | infinite | 0.0000 | | | refraction |
| S18 | image | spherical | infinite | 0.0000 | | | refraction |
| | Surface (IMG) | | | | | | |

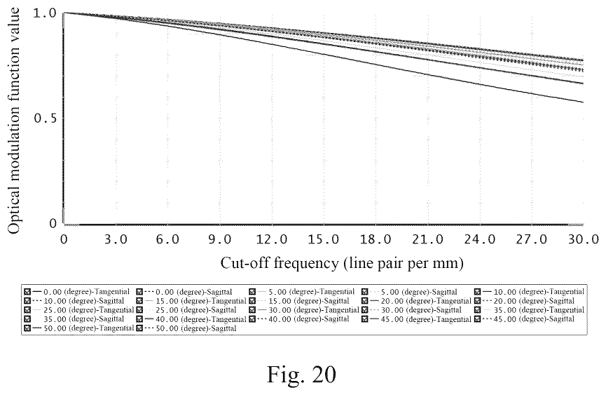

FIG. 18 illustrates a longitudinal aberration curve of the optical system in Embodiment 5, representing deviations of focal points at which lights of different wavelengths passing through the lens assembly converge. FIG. 19 illustrates a distortion curve of the optical system in Embodiment 5, representing amounts of distortion corresponding to different fields-of-view. FIG. 20 illustrates a modulation transfer function (MTF) curve of the optical system in Embodiment 5, representing values of the optical modulation function corresponding to different cut-off frequencies. It can be seen from FIGS. 18-20 that the optical system given in Embodiment 5 can achieve a good imaging quality.

In Embodiments 1-5, an effective focal length f of the optical system, an effective focal length f1 of the first lens, an effective focal length f2 of the second lens, an effective focal length f3 of the third lens, an effective focal length f4 of the fourth lens, an entrance pupil diameter EPD of the optical system, a distance TD from the first side surface of the first lens to the second side surface of the fourth lens on the optical axis, a distance SR from the diaphragm to the first side surface of the first lens on the optical axis, and a sum of center thicknesses ΣCT from the first lens to the fourth lens on the optical axis are shown in Table 6, respectively.

TABLE 6

| | embodiment | | | | |
|---|---|---|---|---|---|
| | embodi- | embodi- | embodi- | embodi- | embodi- |
| parameter | ment 1 | ment 2 | ment 3 | ment 4 | ment 5 |
| f (mm) | 25.27 | 25.37 | 26.18 | 26.15 | 22.44 |
| f1 (mm) | 133.93 | 109.83 | 645.57 | 108.33 | 100.46 |
| f2 (mm) | 141.48 | 119.71 | 102.97 | 128.75 | 157.62 |
| f3 (mm) | −202.49 | −294.36 | −291.81 | −334.39 | −287.95 |
| f4 (mm) | 725.58 | −131.26 | −373.71 | −86.60 | −1523.19 |
| EPD (mm) | 4.00 | 4.00 | 4.00 | 4.00 | 4.00 |
| TD (mm) | 19.78 | 20.64 | 18.85 | 19.97 | 17.86 |
| SR (mm) | 15.00 | 15.00 | 15.00 | 15.00 | 15.00 |
| ΣCT (mm) | 19.56 | 20.42 | 18.63 | 19.75 | 17.64 |

In addition, Embodiments 1-5 respectively satisfy the conditions shown in Table 7 below.

TABLE 7

| | embodiment | | | | |
|---|---|---|---|---|---|
| conditional | embodi- | embodi- | embodi- | embodi- | embodi- |
| expression | ment 1 | ment 2 | ment 3 | ment 4 | ment 5 |
| f2/f1 | 1.06 | 1.09 | 0.16 | 1.19 | 1.57 |
| (CT1 + CTR)/(CTQ1 + | 0.83 | 0.97 | 0.40 | 0.98 | 1.00 |
| CT2) | | | | | |
| f/SR | 1.68 | 1.69 | 1.75 | 1.74 | 1.50 |
| (f2 × N2)/(f3 × N3) | −0.65 | −0.38 | −0.33 | −0.36 | −0.51 |
| (CT2 + CT3)/R4 | −0.39 | −0.26 | −0.19 | −0.26 | −0.31 |
| (CT3 × V3)/(CT4 × V4) | 0.87 | 0.85 | 0.52 | 1.53 | 1.72 |
| TD/(CTR + CTQ1 + | 3.15 | 3.06 | 2.82 | 2.99 | 2.87 |
| CT2) | | | | | |
| R6/R5 | 1.40 | 1.37 | 1.54 | 1.33 | 1.25 |
| f/(NR + NQ1 + NQ2 + | 4.20 | 4.22 | 4.36 | 4.35 | 3.73 |
| NL) (mm) | | | | | |
| CT1/(V1/VR) (mm) | 5.11 | 6.47 | 2.60 | 6.44 | 6.10 |
| f2/(VQ1 + V2) (mm) | 1.26 | 1.06 | 0.91 | 1.14 | 1.39 |
| ΣCT/EPD | 4.89 | 5.10 | 4.66 | 4.94 | 4.41 |
| R7/(V3 + V4) (mm) | −0.53 | −0.77 | −1.20 | −0.76 | −0.93 |
| f/CT2 | 4.17 | 3.89 | 4.06 | 4.05 | 3.73 |
| TD/(N1 + N4) (mm) | 6.43 | 6.71 | 6.13 | 6.49 | 5.57 |

The foregoing is only a description for the preferred embodiments of the present disclosure and the applied technical principles. It should be appreciated by those skilled in the art that the protection scope involved in the present disclosure is not limited to the technical solution formed by the particular combination of the above technical features. The protection scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical system, comprising sequentially along an optical axis from a first side to a second side:
a first lens having a positive refractive power;
a reflective polarizing element;
a first quarter wave plate;
a second lens having a positive refractive power;
a third lens having a negative refractive power;
a partially reflective element;
a fourth lens having a positive refractive power or a negative refractive power;
a second quarter wave plate; and
a polarizer;
wherein, the reflective polarizing element is disposed on a second side surface of the first lens, a first side surface of the reflective polarizing element is at least partially adhered to the second side surface of the first lens; the first quarter wave plate is disposed on a second side surface of the reflective polarizing element, a first side surface of the first quarter wave plate is at least partially adhered to the second side surface of the reflective polarizing element, and a second side surface of the first quarter wave plate is at least partially adhered to a first side surface of the second lens;
the second lens is cemented to the third lens; and the third lens is cemented to the fourth lens;
the optical system satisfies:
$$0.15 < f 2 / f 1 < 1.6 , and$$
$$0.35 < ( CT 1 + CTR ) / ( CTQ 1 + CT 2 ) < 1.05 ,$$
wherein, f2 is an effective focal length of the second lens, f1 is an effective focal length of the first lens, CT1 is a center thickness of the first lens on the optical axis, CTR is a center thickness of the reflective polarizing element on the optical axis, CTQ1 is a center thickness of the first quarter wave plate on the optical axis, and CT2 is a center thickness of the second lens on the optical axis.

2. The optical system according to claim 1, wherein the optical system further comprises a diaphragm disposed on a first side of the first lens, an effective focal length f of the optical system and a distance SR from the diaphragm to a first side surface of the first lens on the optical axis satisfy:
$$1.45 < f / SR < 1.8 .$$

3. The optical system according to claim 1, wherein an effective focal length f2 of the second lens, a refractive index N2 of the second lens, an effective focal length f3 of the third lens and a refractive index N3 of the third lens satisfy:
$$- 0.7 < ( f 2 \times N 2 ) / ( f 3 \times N 3 ) < - 0.3 .$$

4. The optical system according to claim 1, wherein the center thickness CT2 of the second lens on the optical axis, a center thickness CT3 of the third lens on the optical axis and a radius of curvature R4 of a second side surface of the second lens satisfy:
$$- 0.4 < ( CT 2 + CT 3 ) / R 4 < - 0.15 .$$

5. The optical system according to claim 1, wherein a center thickness CT3 of the third lens on the optical axis, an abbe number V3 of the third lens, a center thickness CT4 of the fourth lens on the optical axis and an abbe number V4 of the fourth lens satisfy:
$$0.5 < ( CT 3 \times V 3 ) / ( CT 4 \times V 4 ) < 1.75 .$$

6. The optical system according to claim 1, wherein a distance TD from a first side surface of the first lens to a second side surface of the fourth lens on the optical axis, the center thickness CTR of the reflective polarizing element on the optical axis, the center thickness CTQ1 of the first quarter wave plate on the optical axis and the center thickness CT2 of the second lens on the optical axis satisfy:
$$2.8 < TD / ( CTR + CTQ 1 + CT 2 ) < 3.2 .$$

7. The optical system according to claim 1, wherein a radius of curvature R6 of a second side surface of the third lens and a radius of curvature R5 of a first side surface of the third lens satisfy:
$$1.2 < R 6 / R 5 < 1.6 .$$

8. The optical system according to claim 1, wherein an effective focal length f of the optical system, a refractive index NR of the reflective polarizing element, a refractive index NQ1 of the first quarter wave plate, a refractive index NQ2 of the second quarter wave plate and a refractive index NL of the polarizer satisfy:
$$3.7 mm < f / ( NR + NQ 1 + NQ 2 + NL ) < 4.4 mm .$$

9. The optical system according to claim 1, wherein the center thickness CT1 of the first lens on the optical axis, an abbe number V1 of the first lens and an abbe number VR of the reflective polarizing element satisfy:
$$2.5 mm < CT 1 / ( V 1 / VR ) < 6.5 mm .$$

10. The optical system according to claim 1, wherein the effective focal length f2 of the second lens, an abbe number VQ1 of the first quarter wave plate and an abbe number V2 of the second lens satisfy:
$$0.9 mm < f 2 / ( VQ 1 + V 2 ) < 1.4 mm .$$

11. The optical system according to claim 1, wherein a sum of center thicknesses ΣCT of the first lens, the second lens, the third lens and the fourth lens on the optical axis and an entrance pupil diameter EPD of the optical system satisfy:
$$4.4 < \sum CT / EPD < 5.15 .$$

12. The optical system according to claim 1, wherein a radius of curvature R7 of a first side surface of the fourth lens, the abbe number V3 of the third lens and an abbe number V4 of the fourth lens satisfy:
$$- 1.25 mm < R 7 / ( V 3 + V 4 ) < - 0.5 mm .$$

13. The optical system according to claim 1, wherein an effective focal length f of the optical system and the center thickness CT2 of the second lens on the optical axis satisfy:
$$3.7 < f / CT 2 < 4.2 .$$

14. The optical system according to claim 1, wherein a distance TD from a first side surface of the first lens to a second side surface of the fourth lens on the optical axis, a refractive index N1 of the first lens and a refractive index N4 of the fourth lens satisfy:
$$5.5 mm < TD / ( N 1 + N 4 ) < 6.8 mm .$$

15. The optical system according to claim 1, wherein materials of the first lens, the second lens, the third lens and the fourth lens are plastic.

16. The optical system according to claim 1, wherein the first side surface and the second side surface of each of the first lens, the second lens, the third lens and the fourth lens are spherical surfaces.
